(19) United States
(12) Patent Application Publication
(10) Pub. No.: US 2015/0363210 A1
(43) Pub. Date: Dec. 17, 2015

(54) VEHICLE DOWNLOAD BY REMOTE MOBILE DEVICE

(71) Applicant: Ford Global Technologies, LLC, Dearborn, MI (US)

(72) Inventors: Edward WEHRMAN, Leesburg, VA (US); Stefan BANKOWSKI, Royal Oak, MI (US); Elizabeth HALASH, Dearborn, MI (US)

(21) Appl. No.: 14/303,302

(22) Filed: Jun. 12, 2014

(51) Int. Cl. G06F 9/445

(52) U.S. Cl. CPC G06F 9/445

(57) ABSTRACT

A nomadic device may be configured to receive an indication of a software update to download over a local data connection to a vehicle computing system, download the software update from an update server over an approved wide-area data connection unavailable to the nomadic device when located within the vehicle, and provide the software update to the vehicle computing system for installation to the vehicle. A vehicle computing system may be configured receive, from an update server, an indication of a software update, provide the indication, over a local connection, to a nomadic device configured to download software updates when connected to a wide-area data connection unavailable to the nomadic device when located within the vehicle, and receive the software update, downloaded when connected to the wide-area data connection, from the nomadic device over the local connection.

### TECHNICAL FIELD

This disclosure generally relates to vehicle updates downloaded at least in part by a mobile device.

### BACKGROUND

To update a software version of a component of a vehicle, the vehicle may be driven to a dealership and serviced by a technician. The technician may utilize a system that tracks the individual software levels of every component in the vehicle as well as available software updates. The technician may manually apply the software updates indicated by the system and record any changes back into the system.

### SUMMARY

In a first illustrative embodiment, a system includes a nomadic device configured to receive, over a local data connection to a computing system of a vehicle, an indication of a software update to be installed to the computing system, download the software update from an update server over an approved wide-area data connection unavailable to the nomadic device when located within the vehicle, and provide the software update to the computing system for installation to the vehicle.

In a second illustrative embodiment, a system includes a vehicle computing system configured to receive, from an update server, an indication of a software update, provide the indication over a local connection to a nomadic device configured to download software updates when connected to a wide-area data connection unavailable to the nomadic device when located within the vehicle, and receive the software update, downloaded when connected to the wide-area data connection, from the nomadic device over the local connection.

In a third illustrative embodiment, a computer-implemented method includes providing, from a computing system of a vehicle to a nomadic device, an indication of a software update to be installed to the computing system, the nomadic device configured to download software updates when connected to a wide-area data connection unavailable to the nomadic device when located within the vehicle, and receiving the software update from the nomadic device, downloaded by the nomadic device when connected to the wide-area data connection.

### BRIEF DESCRIPTION OF THE DRAWINGS

FIG. 1 illustrates an example block topology for a vehicle-based computing system for a vehicle;

FIG. 2 illustrates an exemplary vehicle system for providing software updates to the vehicle by way of a nomadic device;

FIG. 3 illustrates an exemplary user interface of the vehicle system for receiving consent from the user to download software updates for the vehicle by the nomadic device;

FIG. 4 illustrates an exemplary user interface of the vehicle system for informing the user of installation of software updates to the vehicle;

FIG. 5 illustrates an exemplary process for utilizing the update management application to identify software update to be installed to the vehicle;

FIG. 6 illustrates an exemplary process for utilizing the update retrieval application to download software update by way of the nomadic device; and

FIG. 7 illustrates an exemplary process for installing downloaded software updates to the vehicle.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Software updates may be delivered to a vehicle through various mechanisms. For example, the vehicle may use a phone or other mobile device as a data connection to retrieve a software update over-the-air. This may allow for the updates to be gathered by the vehicle, but may cause the mobile device to incur undesirable data charges. As another example, a software update may be provided to the vehicle on a universal serial bus (USB) storage device, but access to the USB device may be inconvenient for many end users.

An improved software update system may use a mobile device associated with the vehicle that is configured to retrieve software updates requested by the vehicle. When connected to the vehicle, the mobile device may receive information indicating vehicle software updates to be downloaded. Using the information, the mobile device may be configured to query for and retrieve the indicated software updates when the mobile device is connected to a communications network suitable for downloading the software updates. This may allow the mobile device to gather software updates while connected to a relatively high bandwidth connection, such as the user's home Wi-Fi network. Notably, the suitable connection for downloading the updates may be one that is unavailable when the mobile device is within the vehicle. When the download is complete and the mobile device is reconnected to the vehicle, the mobile device may provide the downloaded software updates to the vehicle for installation.

In some cases, the software update system may further support the downloading of software updates in portions. For instance, a software update may include a plurality of sections, where each section may be separately downloaded and then combined to form the complete update package. In such cases, some or all of the sections may be downloaded using the mobile device, and other sections may be downloaded by the vehicle or received from another source. The mobile device may be configured to send or receive information with the associated vehicle regarding which sections remain to be downloaded, such that the system may retrieve all the required sections for installation.

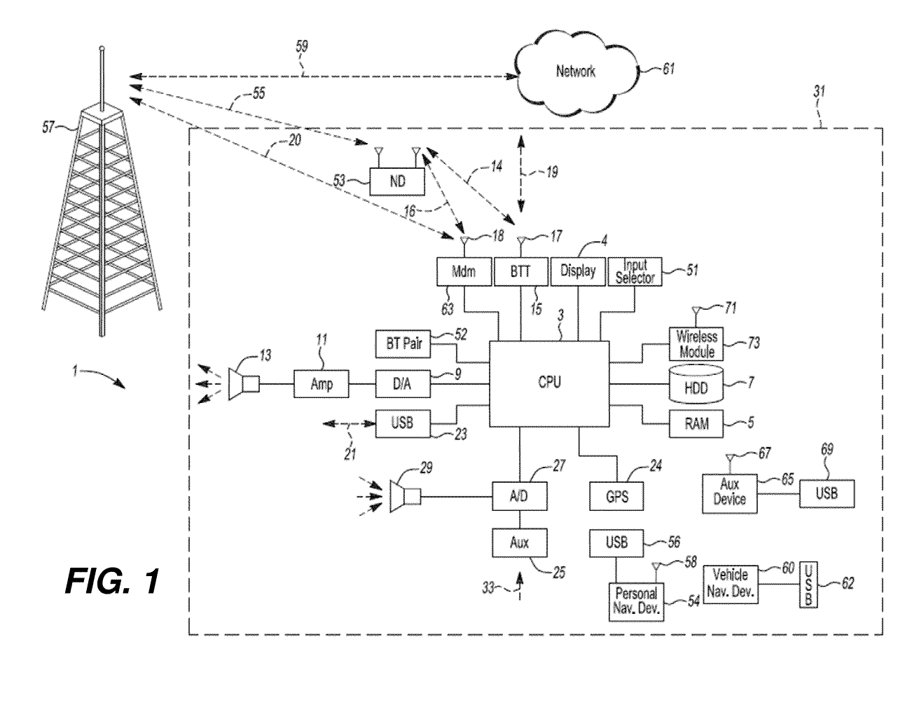

FIG. 1 illustrates an example block topology for a vehicle-based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle 31. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 or central processing unit (CPU) 3 controls at least some portion of the operation of the vehicle-based computing system. Provided within the vehicle 31, the processor 3 allows onboard processing of commands and routines. Further, the processor 3 is connected to both non-persistent 5 and persistent storage 7. In this illustrative embodiment, the non-persistent storage 5 is random access memory (RAM) and the persistent storage 7 is a hard disk drive (HDD) or flash memory. In general, persistent (non-transitory) storage 7 can include all forms of memory that maintain data when a computer or other device is powered down. These include, but are not limited to, HDDs, compact disks (CDs), digital versatile disks (DVDs), magnetic tapes, solid state drives, portable universal serial bus (USB) drives and any other suitable form of persistent storage 7.

The processor 3 is also provided with a number of different inputs allowing the user to interface with the processor 3. In this illustrative embodiment, a microphone 29, an auxiliary input 25 (for input 33), a USB input 23, a global positioning system (GPS) input 24, a screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor 3. Although not shown, numerous of the vehicle components and auxiliary components in communication with the VCS 1 may use a vehicle network (such as, but not limited to, a car area network (CAN) bus) to pass data to and from the VCS 1 (or components thereof).

Outputs to the VCS system 1 can include, but are not limited to, a visual display 4 and a speaker 13 or stereo system output. The speaker 13 is connected to an amplifier 11 and receives its signal from the processor 3 through a digital-to-analog converter 9. Output can also be made to a remote BLUETOOTH device such as personal navigation device (PND) 54 or a USB device such as vehicle navigation device 60 along the bi-directional data streams shown at 19 and 21 respectively.

In one illustrative embodiment, the system 1 uses the BLUETOOTH transceiver 15 to communicate 17 with a nomadic device (ND) 53 (e.g., cell phone, smart phone, PDA, or any other device having wireless remote network connectivity). The nomadic device 53 can then be used to communicate 59 with a network 61 outside the vehicle 31 through, for example, communication 55 with a cellular tower 57. In some embodiments, tower 57 may be a WiFi access point.

Exemplary communication between the nomadic device 53 and the BLUETOOTH transceiver is represented by communication 14.

Pairing a nomadic device 53 and the BLUETOOTH transceiver 15 can be instructed through a button 52 or similar input. Accordingly, the CPU is instructed that the onboard BLUETOOTH transceiver 15 will be paired with a BLUETOOTH transceiver in a nomadic device 53.

Data may be communicated between CPU 3 and network 61 utilizing, for example, a data-plan, data over voice, or dual-tone multiple frequency (DTMF) tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem 63 and communication 20 may be cellular communication.

In one illustrative embodiment, the processor 3 is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the Institute of Electrical and Electronics Engineers (IEEE) 802 personal area network (PAN) protocols. IEEE 802 local area network (LAN) protocols include wireless fidelity (WiFi) and have considerable cross-functionality with IEEE 802 PAN. Both are suitable for wireless communication within a vehicle 31. Another communication means that can be used in this realm is free-space optical communication (such as infrared data association (IrDA)) and non-standardized consumer infrared (IR) protocols.

In another embodiment, nomadic device 53 includes a modem for voice band or broadband data communication. In the data-over-voice embodiment, a technique known as frequency division multiplexing may be implemented when the owner of the nomadic device 53 can talk over the device while data is being transferred. At other times, when the owner is not using the device, the data transfer can use the whole bandwidth (300 Hz to 3.4 kHz in one example). While frequency division multiplexing may be common for analog cellular communication between the vehicle 31 and the Internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle 31. 3G standards are now being replaced by IMT-Advanced (4G) which offers 200 mbs for users in a vehicle 31 and 1 gbs for stationary users. If the user has a data-plan associated with the nomadic device 53, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless LAN device capable of communication over, for example (and without limitation), an 802.11g network (i.e., WiFi) or a WiMax network.

In one embodiment, incoming data can be passed through the nomadic device 53 via a data-over-voice or data-plan, through the onboard BLUETOOTH transceiver and into the processor 3 of the vehicle 31. In the case of certain temporary data, for example, the data can be stored on the HDD or other storage media 7 until such time as the data is no longer needed.

Additional sources that may interface with the vehicle 31 include a PND 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU 3 could be in communication with a variety of other auxiliary devices 65. These devices 65 can be connected through a wireless 67 or wired 69 connection. Auxiliary device 65 may include, but are not limited to, personal media players, wireless health devices, portable computers, and the like.

Also, or alternatively, the CPU 3 could be connected to a vehicle-based wireless router 73, using for example a WiFi (IEEE 803.11) 71 transceiver. This could allow the CPU 3 to connect to remote networks within range of the local router 73.

In addition to having exemplary processes executed by a vehicle computing system located in a vehicle 31, in certain embodiments, the exemplary processes may be executed at least in part by one or more computing systems external to and in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process includes a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the VCS 1 located within the vehicle 31 itself is capable of performing the exemplary processes.

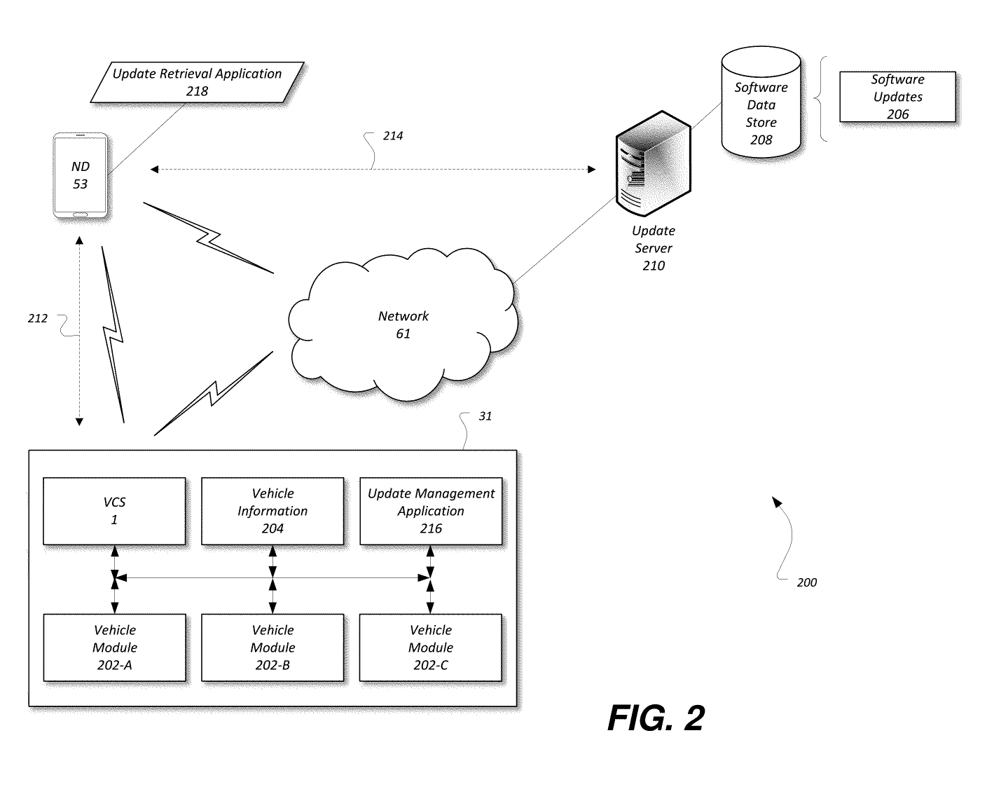

FIG. 2 illustrates an exemplary vehicle 31 system 200 for providing software updates 206 to the vehicle 31 by way of a nomadic device 53. The system 200 may include the VCS 1 in communication over the network 61 with an update server 210 (e.g., directly, or via the nomadic device 53). The update server 210 may communicate with a software data store 208 configured to maintain software updates 206 for download. The system 200 may further include an update management application 216 installed to the vehicle 31 and configured to install software updates 206 to various modules 202-A through 202-C (collectively 202) of the vehicle 31. The nomadic device 53 may be in communication with the update server 210 via a wide-area data connection 214 and with the update management application 216 of the VCS 1 via a local data connection 212. As explained in detail below, an update retrieval application 218 installed to the nomadic device 53 may be configured to receive indications of software updates 206 to download from the update management application 216, download the software updates 206 when the nomadic device 53 is connected to a suitable wide-area data connection 214 away from the vehicle 31, and provide the downloaded software updates 206 to the VCS 1 when the nomadic device 53 is returned to the vehicle 31. While an exemplary system 200 is shown in FIG. 2, the exemplary components illustrated in the Figure are not intended to be limiting. Indeed, the system 200 may have more or fewer components, and additional or alternative components and/or implementations may be used.

The vehicle modules 202 may include various vehicle 31 components configured to receive updates of associated software, firmware, or configuration settings. As some non-limiting examples, the vehicle modules 202 may include a powertrain control module (PCM), a brake system control module (BSCM), a body control module (BCM), and the VCS 1 itself.

The vehicle information 204 may include information configured to identify the vehicle 31 or the vehicle 31 configuration. For example, the vehicle information 204 may include a vehicle identification number (VIN) published to the vehicle 31 CAN bus, or subscriber identity module (SIM) information of the modem 63 such as international mobile station equipment identity (IMEI). Additionally or alternately, the vehicle information 204 may include version information for at least a portion of the hardware and software components of the vehicle modules 202 of the vehicle 31.

The software updates 206 may include changes to the software or settings of the vehicle 31 to address an issue with the current software or settings, or to provide improved functionality to the current software. The software updates 206 may include, for example, updated configuration settings for one or more vehicle modules 202, and/or updated versions of software or firmware to be installed on one or more vehicle modules 202. In some cases software updates 206 may include a single section, while in other cases a software updates 206 may be organized into multiple subsections, partitions, or chunks, where all the subsections may be downloaded to complete the overall software update 206 to be installed.

The software data store 208 may be configured to store the software updates 206. The software data store 208 may be further configured to store additional information regarding the maintained software updates 206. For example, the software data store 208 may be configured to maintain indications of which vehicle module(s) 202 are associated with which software updates 206. The software data store 208 may further store information indicative of the compatibility of the software updates 206 to vehicle model or configuration. For instance, a storage entry for a software update 206 may indicate that the software update 206 is compatible with a certain make and model of vehicle 31, or that it has a dependency on a version of another vehicle module 202 being of a particular version or versions.

The update server 210 may include one or more devices configured to serve the software updates 206 stored by the software data store 208 to the vehicles 31. For example, the update server 210 may be configured to receive requests for available software updates 206 from vehicles 31. The requests may include vehicle information 204 to allow the update server 210 to query the software data store 208 for software updates 206 applicable to the vehicle 31 as it is currently configured. The update server 210 may provide, responsive to the requests, indications of software updates 206 to update the requesting vehicle 31 that may be downloaded and installed. The update server 210 may be further configured to serve the software updates 206 to devices requesting to downloaded the software updates 206 according to the provided indications.

The VCS 1 may be configured to communicate with the update server 210 over the network 61. In some cases, the VCS 1 may make use of integrated network functionality of the VCS 1, such as the internal modem 63, to facilitate communication with the update server 210. In other cases, the VCS 1 may utilize a local data connection 212 to the nomadic device 53 to facilitate communication with the update server 210 via a wide-area data connection 214 of the nomadic device 53. As an example, for a nomadic device 53 running the Android operating system maintained by the Open Handset Alliance of Silicon Valley, Calif., the data connection 212 may be established via a wireless Bluetooth connection. As another example, for a nomadic device 53 running the iOS operating system maintained by Apple, Inc. of Cupertino, Calif., the data connection 212 may additionally or alternately be established over a wired USB connection (not shown).

The nomadic device 53 may further be configured to establish a wide-area data connection 214 (e.g., an Internet connection) between the nomadic device 53 and the update server 210, such as a connection over the network 61. The nomadic device 53 may be further configured to maintain information regarding which wide-area data connections 214 may be preferred by the user for downloading information (or which types of wide-area data connections 214). For instance, to avoid mobile data plan overage charges, the nomadic device 53 may be configured to defer requests to download files when connected to the network 61 via a cellular wide-area data connection 214, and may be configured to handle the download requests (including any deferred requests) when connected to a Wi-Fi wide-area data connections 214. As another possibility, the nomadic device 53 may be configured to defer requests until the nomadic device 53 is connected to the network 61 via a wide-area data connection 214 on a list of preferred wide-area data connections 214 (e.g., selected by the user from a network control panel user interface of the nomadic device 53).

Due to the nomadic nature of the nomadic device 53, it should be noted that the nomadic device 53 may maintain a wide-area data connection 214 in some cases when it is not in communication with the VCS 1 over the data connection 212. As one example, the nomadic device 53 may utilize the wide-area data connection 214 over a home Wi-Fi network of the user when the nomadic device 53 is not paired with or within the vicinity of the vehicle 31.

The update management application 216 may be configured to manage the installation of software updates 206 to the vehicle 31. For example, the update management application 216 of the VCS 1 may receive a command from a user requesting to check for software updates 206. As another possibility, the update management application 216 may trigger a periodic check for new software updates 206. When triggered, the update management application 216 may be configured to send a request to the update server 210 to inquire whether software updates 206 for the vehicle 31 are available. For example, the update management application 216 may query the update server 210 using the vehicle information 204 (or, if the software data store 208 maintains current vehicle information 204, an identifier of the vehicle 31), and may receive a response from the update server 210 indicative of whether new software updates 206 for the vehicle 31 are available (e.g., as links or other identifiers of software updates 206 for the vehicle 31 to download). If the response to the update management application 216 indicates software updates 206 are available for the vehicle 31, the update management application 216 may be further configured to queue those software updates 206 to be downloaded and installed.

The update retrieval application 218 may be configured to cause the nomadic device 53 to download software updates 206 over the wide-area data connection 214. For instance, the update retrieval application 218 may be configured to receive a listing of the software update 206 identified by the update management application 216 as being available for download and install. The update retrieval application 218 may be further configured to detect when the nomadic device 53 has access to a wide-area data connection 214 suitable for download of the software updates 206, and may perform the downloads when so connected. As an example, the update retrieval application 218 may be configured to download the updates over predefined approved connections or connection types. As a possibility, the predefined connections or connection types may be selected by the user from a network control panel user interface of the update retrieval application 218. As another possibility, the update retrieval application 218 may simply prefer certain types by default (e.g., to prefer Wi-Fi connections over cellular). The approved connections or connection types may be utilized to avoid incurring data usage charges or roaming charges for retrieving the vehicle 31 update. In one possibility, the update retrieval application 218 may be configured to download the software updates 206 while connected to a relatively high bandwidth wide-area data connection 214 away from the vehicle 31 such the user's home Wi-Fi network.

By using the facilities of the nomadic device 53, the vehicle 31 may accordingly be able to have its software updates 206 downloaded over wide-area data connections 214 that may be unavailable to the vehicle 31 but available to the nomadic device 53. Thus, the update retrieval application 218 may allow the nomadic device 53 to download software updates 206 when the nomadic device 53 is away from the vehicle 31 but connected to the network 61.

When the nomadic device 53 is returned to the vehicle 31, the update retrieval application 218 may be configured to provide the downloaded software updates 206 to the VCS 1. The update retrieval application 218 may also be configured to provide status information to the update management application 216 of the VCS 1 indicating what software updates 206 or portions of software updates 206 have been downloaded. As another possibility, the update management application 216 may be configured to query the nomadic device 53 for the status of any downloaded software updates 206, and the update retrieval application 218 may be configured to respond with any downloaded software updates 206, as well as with status information indicating what software updates 206 or portions of software updates 206 have been downloaded.

In some cases, some software updates 206 or sections of software updates 206 may be downloaded using the nomadic device 53, while other software updates 206 or sections of software updates 206 may be downloaded by the vehicle 31. The update management application 216 may be further configured to manage identification of which software updates 206 or sections of software updates 206 have been downloaded, and which may still need to be updated. This updated information on what still required downloading may be provided as an updated listing by the update management application 216 to the update retrieval application 218. Thus, if a software update 206 or portion of a software update 206 is received by the VCS 1 in some other manner (e.g., by download by the VCS 1, by download using another nomadic device 53 associated with the VCS 1, etc.), the nomadic device 53 may be apprised of the update status and may remove the retrieved software update 206 from its listing of software updates 206 to download.

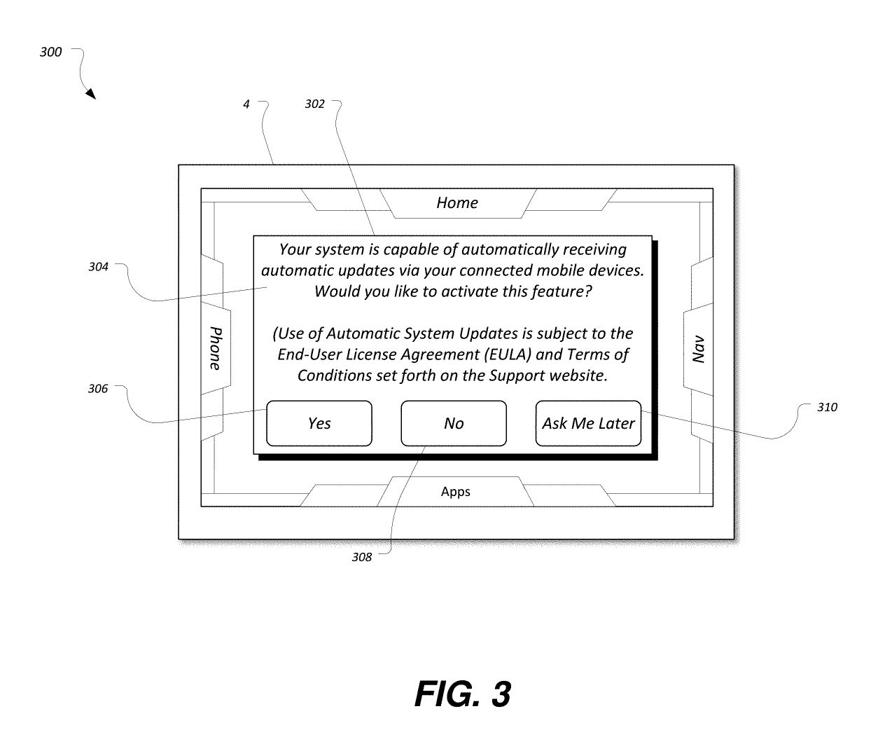

FIG. 3 illustrates an exemplary user interface 300 of the vehicle system 200 for receiving consent from the user to download software updates 206 for the vehicle 31 by the nomadic device 53. The user interface 300 may be presented by the VCS 1 in the vehicle 31 via the display 4, and may include a message prompt 302 provided by the update management application 216 to request for the user to agree to use of the update retrieval application 218 to download software updates 206 for the vehicle 31. As illustrated, the message prompt 302 is included in the user interface 300 as a message above other content of the user interface 300. It should be noted that in other examples, the message prompt 302 may be provided in other forms, such as via a full-screen user interface.

The user interface 300 may further include controls configured to receive an indication from the user whether the user agrees to use of the update retrieval application 218. As an example, the user interface 300 may include a yes control 306 for receiving an indication from the user that the user agrees to use of the update retrieval application 218, a no control 308 for receiving an indication from the user that the user disagrees with use of the update retrieval application 218, and a ask-me-later control 310 for receiving an indication from the user that the user wishes to be provided with the message prompt 302 at a later date. If the user agrees to use of the update retrieval application 218, then the update management application 216 may utilize the update retrieval application 218 to aid in the download of software updates 206 to the vehicle 31. Otherwise, the update management application 216 may fall back to functionality not using the update retrieval application 218, such as use of the nomadic device 53 as a data connection (if authorized to do so by the user), use of an internal onboard modem 63 of the VCS 1, or software updates 206 may be unavailable.

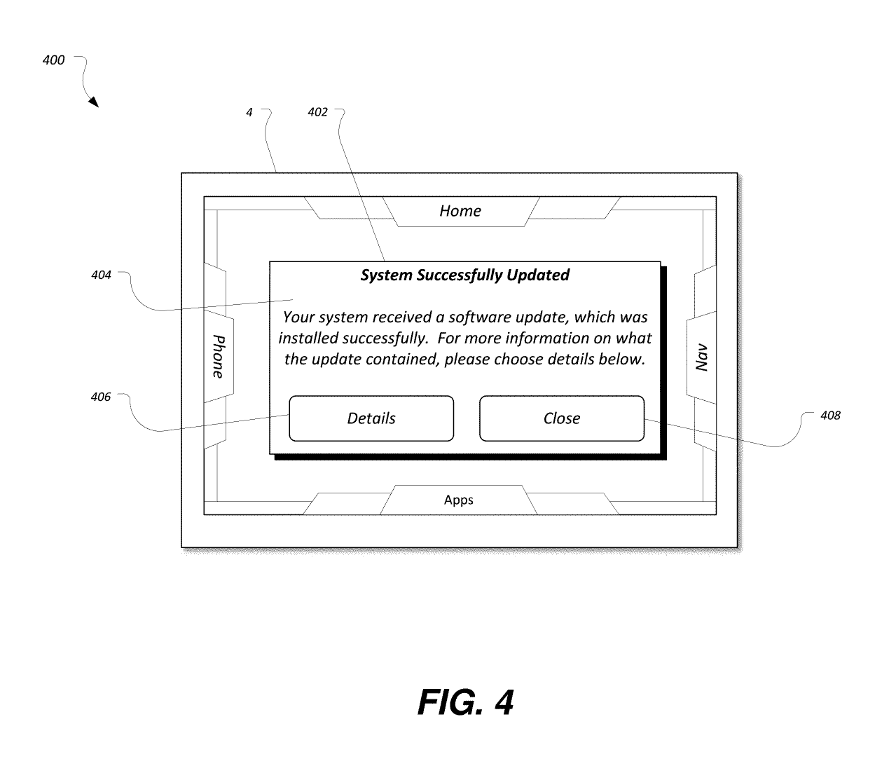

FIG. 4 illustrates an exemplary user interface 400 of the vehicle system 200 for informing the user of installation of software updates 206 to the vehicle 31. As with the user interface 300, the user interface 300 may be presented by the VCS 1 in the vehicle 31 via the display 4. The user interface 400 may further include a message prompt 402 provided by the update management application 216 to inform the user of the installation of software updates 206 to the vehicle 31. The user interface 400 may further include controls configured to receive an indication from the user whether the user would like to view details of the updates installed by the update management application 216. As an example, the user interface 400 may include a details control 406 for receiving an indication from the user that the user would like to view details of the installed software updates 206, and a close control 408 for receiving an indication from the user does not desire to view the installation details. The installation details may include information such as which vehicle modules 202 were updated and what versions of software updates 206 were installed. As the software updates 206 may be installed by the update management application 216 automatically, the message prompt 402 may accordingly allow the user to be informed of the status of the automatic vehicle 31 updates.

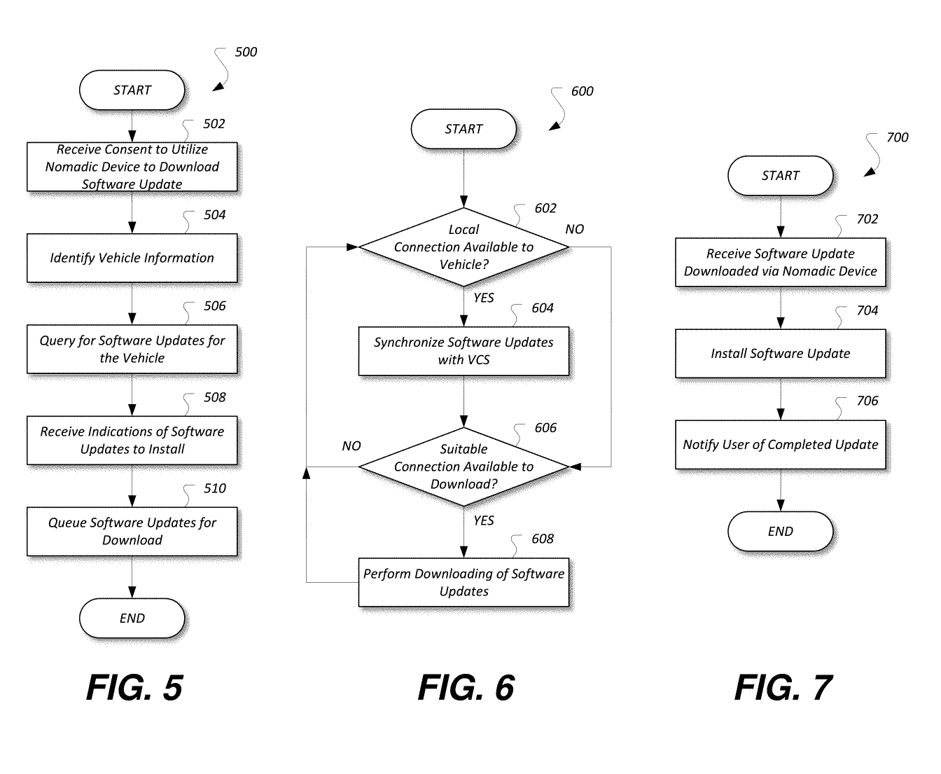

FIG. 5 illustrates an exemplary process 500 for utilizing the update management application 216 to identify software update 206 to be installed to the vehicle 31. The process 500 may be performed, for example, by the VCS 1 executing the update management application 216 and in communication with the update retrieval application 218 executed by the nomadic device 53.

At operation 502, the update management application 216 receives consent from the user to utilize the update retrieval application 218 executed by the nomadic device 53 to download software updates 206. For example, the update management application 216 may present the message prompt 302 to the user via the display 4, and may receive input via the yes control 306 that the user agrees to use of the update retrieval application 218 to aid in the download of software updates 206 to the vehicle 31.

At operation 504, the update management application 216 identifies vehicle information 204. For example, the VCS 1 may be configured to query for existence and version information for at least a portion of these hardware and software components of the vehicle modules 202 of the vehicle 31.

At operation 506, the update management application 216 queries for software updates 206 for the vehicle 31. For instance, the update management application 216 may be configured to send a request to the update server 210 to inquire whether software updates 206 for the vehicle 31 are available. In an example, the update management application 216 may query the update server 210 using an identifier of the vehicle 31 (e.g., vehicle 31 VIN, vehicle 31 SIM information, etc.).

At operation 508, the update management application 216 receives indications of software updates 206 to install. For example, responsive to the query for software updates 206 for the vehicle 31, the update management application 216 may receive from the update server 210 a response from the update server 210 indicative of whether new software updates 206 for the vehicle 31 are available (e.g., as links or other identifiers of software updates 206 for the vehicle 31 to download).

At operation 510, the update management application 216 queues the software updates 206 to be installed. For example, if the response to the update management application 216 from the update server 210 indicates software updates 206 are available for the vehicle 31, the update management application 216 may be further configured to queue those software updates 206 to be downloaded and installed. After operation 510, the process 500 ends.

FIG. 6 illustrates an exemplary process 600 for utilizing the update retrieval application 218 to download software update 206 by way of the nomadic device 53. The process 600 may be performed, for example, by the VCS 1 executing the update management application 216 and in communication with the update retrieval application 218 executed by the nomadic device 53.

At operation 602, the update retrieval application 218 determines whether a local data connection 212 to the VCS 1 is available. As an example, for a nomadic device 53 running the Android operating system, the update retrieval application 218 may determine whether the nomadic device 53 indicates that a data connection 212 is established with the VCS 1 via a wireless Bluetooth connection. As another example, for a nomadic device 53 running the iOS operating system, the update retrieval application 218 may additionally or alternately determine whether the nomadic device 53 indicates that a data connection 212 is established over a wired USB connection. If the update retrieval application 218 determines that the local data connection 212 to the VCS 1 is available, control passes to operation 604. Otherwise control passes to operation 606.

At operation 604, the update retrieval application 218 synchronizes the software updates 206 to be installed with the update management application 216. For example, the update retrieval application 218 may be configured to receive a listing of the software update 206 identified by the update management application 216 as being available for download and install. As another example, the update retrieval application 218 may be configured to provide status information to the update management application 216 of the VCS 1 indicating what software updates 206 or portions of software updates 206 have been downloaded to the nomadic device 53.

At operation 606, the update retrieval application 218 determines whether a wide-area data connection 214 between the nomadic device 53 and the update server 210 is available. For instance, the update retrieval application 218 may detect when the nomadic device 53 has access to a wide-area data connection 214 suitable for download of the software updates 206, and may perform the downloads when so connected. For example, the update retrieval application 218 may be configured to download the updates over predefined approved connections or connection types, to avoid incurring usage charges or roaming charges for capturing the vehicle 31 update. As one possibility, the update retrieval application 218 may be configured to download the software updates 206 while connected to a relatively high bandwidth wide-area data connection 214 away from the vehicle 31 such the user's home Wi-Fi network. If a suitable wide-area data connection 214 is available, control passes to operation 608. Otherwise, control passes to operation 602.

At operation 608, the update retrieval application 218 performs downloading of software updates 206. Accordingly, by using the facilities of the nomadic device 53, the vehicle 31 may be able to have its software updates 206 downloaded over wide-area data connections 214 that may be unavailable to the vehicle 31 but available to the nomadic device 53. Thus, the update retrieval application 218 may allow the nomadic device 53 to download software updates 206 when the nomadic device 53 is away from the vehicle 31 but connected to the network 61. After operation 608, control passes to operation 802.

FIG. 7 illustrates an exemplary process 700 for installing downloaded software updates 206 to the vehicle 31. The process 700 may be performed, for example, by the VCS 1 executing the update management application 216 and in communication with the update retrieval application 218 executed by the nomadic device 53.

At operation 702, the update management application 216 receives a software update 206 downloaded by the nomadic device 53. For example, when the nomadic device 53 is returned to the vehicle 31 after downloading a software update 206 via a suitable wide-area data connection 214, the update retrieval application 218 may be configured to provide the downloaded software updates 206 to the VCS 1.

At operation 704, the update management application 216 installs the downloaded software update 206. For example, the update management application 216 may provide the updated configuration or software to the vehicle module 202 or modules 202 being updated.

At operation 706, the update management application 216 notifies the user of the completed update. For example, the update management application 216 may present the message prompt 402 to the user via the display 4 to inform the user of the installation of software updates 206 to the vehicle 31. After operation 706, the process 700 ends.

Variations on the disclosed processes are possible. For example, in some cases the update retrieval application 218 may be configured to query the update server 210 for the software updates 206 to be installed. As another example, in some cases the update retrieval application 218 may be configured to prioritize certain software updates 206 over other updates. For example, if a software update 206 to be installed is indicated as being a high priority update, then the update retrieval application 218 may be configured to retrieve that high priority software update 206 over any available connection, without waiting for a preferred connection or connection type.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a nomadic device configured to
receive, over a local data connection to a computing system of a vehicle, an indication of a software update to be installed to the computing system,
download the software update from an update server over an approved wide-area data connection unavailable to the nomadic device when located within the vehicle, and
provide the software update to the computing system for installation to the vehicle.

2. The system of claim 1, wherein the nomadic device is further configured to verify that the approved wide-area data connection is included in a predefined listing of approved connections for downloading software updates.

3. The system of claim 1, wherein the nomadic device is further configured to verify that the approved wide-area data connection is included in a predefined listing of approved connection types for downloading software updates.

4. The system of claim 1, wherein the nomadic device is further configured to provide the software update over the local data connection to the computing system.

5. The system of claim 1, wherein the nomadic device is further configured to provide status information to the computing system indicating what portions of software updates have been downloaded by the nomadic device.

6. The system of claim 1, wherein the nomadic device is a mobile phone.

7. A system comprising:
a vehicle computing system configured to
receive, from an update server, an indication of a software update,
provide the indication, over a local connection, to a nomadic device configured to download software updates when connected to a wide-area data connection unavailable to the nomadic device when located within the vehicle, and
receive the software update, downloaded when connected to the wide-area data connection, from the nomadic device over the local connection.

8. The system of claim 7, wherein the vehicle computing system is further configured to query the update server for software updates for the vehicle.

9. The system of claim 7, wherein the vehicle computing system is further configured to receive consent from a user to utilize a nomadic device of the user to download software updates before providing the indication of the software update to the nomadic device.

10. The system of claim 7, wherein, upon installation of the software update, the vehicle computing system is further configured to provide a notification in a user interface that the software update has been installed to the vehicle.

11. The system of claim 7, wherein the vehicle computing system is further configured to receive status information from the nomadic device indicating what portions of software updates have been downloaded to the nomadic device.

12. The system of claim 7, wherein the nomadic device is a mobile phone.

13. A computer-implemented method comprising:
providing, from a computing system of a vehicle to a nomadic device, an indication of a software update to be installed to the computing system, the nomadic device configured to download software updates when connected to a wide-area data connection unavailable to the nomadic device when located within the vehicle; and
receiving the software update from the nomadic device, downloaded by the nomadic device when connected to the wide-area data connection.

14. The method of claim 13, further comprising:
querying an update server for software updates for the vehicle; and
receiving the indication of the software update to be installed from the update server responsive to the querying.

15. The method of claim 13, further comprising receiving consent from a user to utilize a nomadic device of the user to download software updates before providing the indication of the software update to the nomadic device.

16. The method of claim 13, further comprising, upon installation of the software update, providing a notification in a user interface that the software update has been installed to the vehicle.

17. The method of claim 13, further comprising receiving status information from the nomadic device indicating what portions of software updates have been downloaded to the nomadic device.
